(19) United States
(12) Patent Application Publication
(10) Pub. No.: US 2008/0261792 A1
(43) Pub. Date: Oct. 23, 2008

(54) Device for Producing Flexible Tubes from a Flat Film

(76) Inventors: Bernd Wilke, Leutenbach (DE); Helmut Weber, Weinstadt-Beutelsbach (DE); Michael Gensheimer, Stuttgart (DE); Carsten Gruber, Ebersbach/Fils (DE); Markus Trugenberger, Deizisau (DE); Oleg Schneider, Stuttgart (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 11/794,093

(22) PCT Filed: Dec. 5, 2005
(86) PCT No.: PCT/EP05/56471

§ 371 Date: Feb. 15, 2008

(30) Foreign Application Priority Data
Dec. 23, 2004 (DE) 10 2004 062 025.3

(51) Int. Cl. B31B 31/00

(52) U.S. Cl. 493/186

(57) ABSTRACT

The present invention relates to a device for manufacturing tubes from a flat film material, including first and second essentially concave rollers, a forming tube situated between the first and second rollers, and a longitudinal sealing device for sealing a longitudinal seam of the tube; the essentially concave rollers each include a multitude of individual disks mounted for free rotation relative to one another about a common axis.

### PRIOR ART

The present invention relates to a device for manufacturing tubes or bags from a flat film web.

A wide variety of embodiments of devices for manufacturing tubes or bags are known from the prior art. For example, DE 4335577 A1 has disclosed a method and device for manufacturing, filling, and sealing bags in which a tube-forming device and a longitudinal seam-sealing device form a tube from an endless web of plastic film. The known tube-forming device has a forming shoulder and a forming tube. The film web is drawn over the forming shoulder and the forming tube and is wrapped around the forming tube and then sealed by the longitudinal seam-sealing device to form a tube. Very high withdrawal forces act on the forming shoulder in the process of this. These high withdrawal forces result from the mass moment of inertia of the film web roll, the static friction of the film web on the packaging material web, the bearing friction of the deflection rollers, the shape of the forming shoulder, and the frictional resistance of the film web itself. It is therefore difficult for the known devices to process films with higher frictional coefficients.

Moreover, with the known devices, it is necessary to keep on hand various forming sets, in particular various forming shoulders in order to be able to manufacture tubes or bags with different dimensions. On the one hand, this requires set-up times for re-equipping the machine and on the other hand, requires a multitude of forming sets of various sizes, which increases manufacturing costs.

### ADVANTAGES OF THE INVENTION

The device according to the invention for manufacturing tubes out of a flexible film, with the defining characteristics of claim 1, has the advantage over the prior art that the withdrawal forces on the device can be significantly reduced. This yields the advantage of permitting it to process very thin films or films with very high friction forces. It is also possible according to the invention to easily convert the device to different tube diameters without requiring complex conversion work or other parts of a forming set. This is achieved according to the invention by virtue of the fact that the device has a first and second essentially concave roller. Between the first and second roller, there is a forming tube, which predetermines the diameter of the tube to be produced. The forming tube is followed by a longitudinal sealing device, which seals a longitudinal seam of the tube in order to manufacture the tube out of the flat film. According to the invention, the essentially concave rollers are each comprised of a multitude of individual disks. The outer diameter of the individual disks is selected in such a way that in a side view of the rollers, the roller narrows to a minimum diameter and then widens out again starting from the minimum diameter. In this case, the shape of the rollers is preferably semicircular or parabolic when viewed from the side. The individual disks are able to rotate freely.

Preferred modifications of the invention are disclosed in the dependent claims.

Preferably, the individual disks of the first and second roller are selected in such a way that they have a continuously changing outer diameter across the thickness of the disk. The change is preferably linear or particularly preferably arc-shaped. In an arc-shaped change, with an embodiment of the outer diameter that is arc-shaped when viewed in cross section, it is possible to achieve a continuous transition from one disk to the adjacent disk.

It is also preferable if one of the rollers has a gap between two neighboring disks. The two united edges of the film can be conveyed through the gap and supplied to the longitudinal sealing device. This makes it possible to avoid a bending or folding at the edges.

It is particularly preferable if the first and second rollers are situated so that they touch each other. The rollers are embodied as being of the same size so that the contact points of the rollers lie at their respective outer edges in the axial direction.

It is particularly preferable if the individual disks of the two rollers each have the same thickness in the axial direction of the rollers.

According to another preferred embodiment of the present invention, the two rollers are situated parallel to each other.

It is also preferable if the forming tube is embodied as hollow and is used as the filling pipe for the tube being manufactured. This makes it possible to achieve a particularly compact device.

It is also preferable if the device according to the invention has a lateral sealing device, which produces a seal of the tube in the lateral direction. The lateral sealing device is situated beneath the forming tube. This makes it possible to manufacture a multitude of bags of the same length or different lengths from the elongated tube. The lateral sealing device seals both the one end and the other end of the tube.

### DRAWINGS

An exemplary embodiment of the invention will be explained in detail with reference to the accompanying drawings.

FIG. 1 is a schematic perspective view of a device for manufacturing tubes according to an exemplary embodiment of the present invention,

FIG. 2 is a schematic side view of a first and second roller according to the exemplary embodiment shown in FIG. 1,

FIG. 3 is a schematic side view of an assembly procedure for a roller,

FIG. 4 is a schematic top view of an individual disk for a roller according to the invention, and

FIG. 5 is a schematic side view of the roller disk shown in FIG. 4.

### DESCRIPTION OF THE EXEMPLARY EMBODIMENT

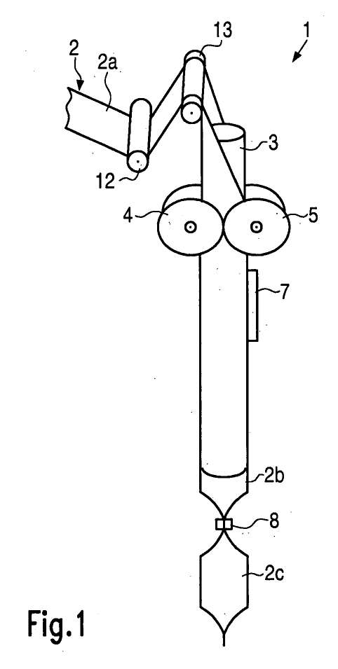

A device 1 for manufacturing tubes or bags according to an exemplary embodiment of the present invention will be described below with reference to FIGS. 1 through 5.

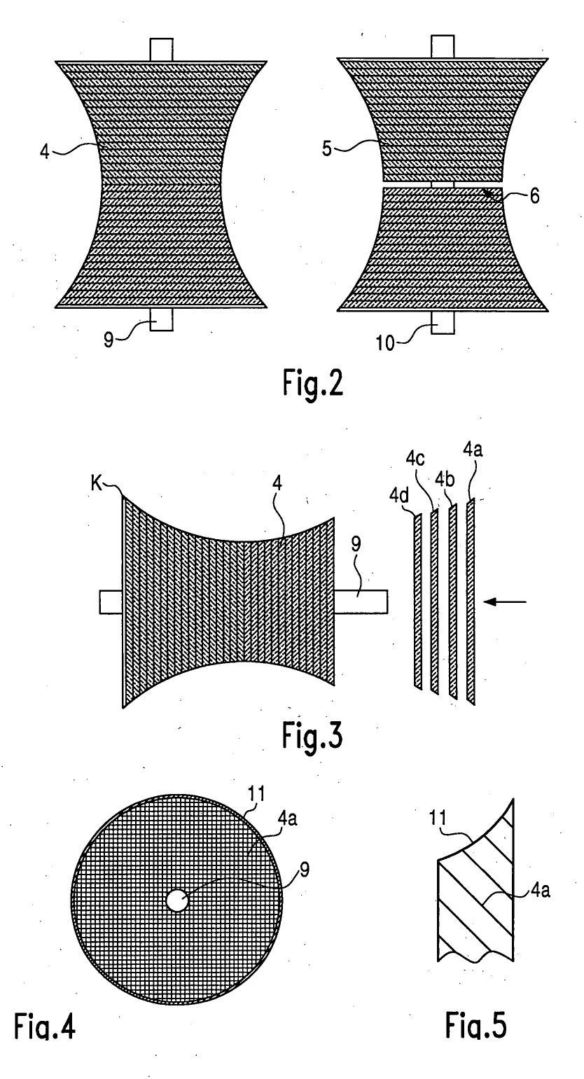

As shown in FIG. 1, the device 1 according to the invention for manufacturing tubes out of a flat film 2 includes a forming tube 3, which is embodied as a hollow cylindrical tube. The forming tube 3 is situated between a first roller 4 and a second roller 5. The two rollers 4 and 5 are shown more closely in the detail shown in FIG. 2. In addition, the rollers 4, 5 are followed by a longitudinal sealing device 7, which longitudinally seals the resulting tube. The longitudinal sealing device 7 is in turn followed by a lateral sealing device 8, which makes it possible to seal the tube in the horizontal direction, thus making it possible to manufacture tubular bags 2c of a predetermined length.

As is particularly clear from FIGS. 2 and 3, the rollers 4 and 5 each have an essentially concave form such that the outer diameter of the rollers narrows toward the middle from a first outside in the axial direction of the roller and then widens out again continuously from the middle to the second outside in the axial direction. The two rollers 4, 5 are each composed of a multitude of individual disks, which, when assembled, produce the continuous curve of the outer circumference surface of the rollers.

FIG. 3 schematically depicts an assembly process of individual disks 4a, 4b, 4c, 4d onto a cylindrical axle 9 of the first roller 4. The individual disks 4a, 4b, 4c, 4d of the rollers 4, 5 each have the same respective width. In a schematic sectional view, FIG. 5 shows a geometric curve of an outer circumference surface of a disk 4a. As is clear from FIG. 5, the course of the disk 4a in the width direction is bowed, thus yielding a curve that is arc-shaped when viewed from the side in the assembled state, as is particularly clear in FIGS. 2 and 3.

As shown in FIGS. 1 and 2, the axles 9, 10 of the first roller 4 and second roller 5 are situated parallel to each other. The individual disks of the rollers 4, 5 are arranged on the axles 9 and 10 so that they can rotate independently of one another. This assures that the film 2 is conveyed downward through the rollers 4, 5 at a uniform speed. It is thus possible to prevent the different radii in the longitudinal direction of the roller from producing different circumferential speeds during the production of the tube, thus enabling the production of tubes with uniformly high quality. The invention thus makes it possible to reduce the withdrawal forces in bag forming, filling, and sealing machines, which means that it is also possible to process very thin films or films with very high friction forces.

As is also clear from FIG. 2, the second roller 5 differs from the first roller by virtue of a gap 6, which is formed at the point of the second roller 5 with the smallest diameter. This gap 6 serves to permit the edges of the flat film 2 to pass through as it is guided around the forming tube 3 as shown in FIG. 1. The two edges are laid parallel to each other and guided through the gap 6 and then supplied to the longitudinal sealing device 7, which welds the two edges to each other so as to produce a closed tube.

The device according to the invention is thus able to draw a flat region 2a of the foil 2, which is usually rolled onto a large packaging material roll, over deflection rollers 12 and 13 and guide it around the forming tube 3. The forming tube 3 situated between the two rollers 4, 5 is in contact with the rollers 4, 5 so that the film 2 is guided around the forming tube and its edges are brought together just above the gap 6 of the second roller 5. Then the edges of the film 2 are guided through the gap and welded to each other by means of the longitudinal sealing device 7. This produces an elongated tubular region 2b.

If so desired, a filling material can be immediately dispensed into the tubular region 2b via the hollow forming tube 3. In order to prevent the filling material from falling through the tubular region 2b, the lateral sealing device 8 has first sealed the tubular region 2b in the horizontal direction so that the half-finished tubular bag catches the filling material. Then the tube is transported further and the lateral sealing device 8 once again executes a horizontal sealing procedure, producing a completely packaged tubular bag 2c.

In addition, the present invention permits a simple format change in that the concave rollers can be changed by subtracting or adding other disks and a correspondingly changed forming tube 3 is used. This makes it possible to quickly and easily manufacture different tube diameters with a single forming device. According to the invention, it is thus possible to achieve higher production speeds through reduced friction since this minimizes the risk of the film tearing. Furthermore, the cost for manufacturing the rollers is significantly reduced in comparison to the known forming shoulders. The present invention also offers the possibility of using packaging materials for the film material, which the previously known machines were unable to process.

It should be noted that the device according to the invention preferably includes an adjustable forming tube, which can be adjusted to different diameters. This makes it possible to manufacture tubes with different tube diameters. It is thus not necessary to keep a range of different forming tubes on hand.

1-10. (canceled)

11. A device for manufacturing tubes from a flat film material, the device comprising a first essentially concave roller, a second essentially concave roller, a forming tube situated between the first and second roller, and a longitudinal sealing device for sealing a longitudinal seam of the tube, the first and second essentially concave rollers each including a multitude of individual disks mounted for free rotation relative to one another about a common axis.

12. The device according to claim 11, wherein the outer diameter of each individual disk of the rollers changes continuously over the thickness.

13. The device according to claim 12, wherein the outer circumference of each individual disk of each roller is embodied in such a way that the outer circumference of the rollers have a bowed, in particular arc-shaped or paraboloid, form when viewed in cross section.

14. The device according to claim 11, further comprising a gap between two adjacent disks, through which it is possible to convey the united edges of the film material.

15. The device according to claim 12, further comprising a gap between two adjacent disks, through which it is possible to convey the united edges of the film material.

16. The device according to claim 13, further comprising a gap between two adjacent disks, through which it is possible to convey the united edges of the film material.

17. The device according to claim 11, wherein the first roller and the second roller are mounted so as to touch each other.

18. The device according to claim 12, wherein the first roller and the second roller are mounted so as to touch each other.

19. The device according to claim 13, wherein the first roller and the second roller are mounted so as to touch each other.

20. The device according to claim 14, wherein the first roller and the second roller are mounted so as to touch each other.

21. The device according to claim 11, wherein the individual disks of the respective rollers each have the same thickness in the axial direction.

22. The device according to claim 11, wherein the first and second rollers are mounted with their axes parallel.

23. The device according to claim 12, wherein the first and second rollers are mounted with their axes parallel.

24. The device according to claim 13, wherein the first and second rollers are mounted with their axes parallel.

25. The device according to claim 11, wherein the forming tube is embodied as hollow.

26. The device according to claim 12, wherein the forming tube is embodied as hollow.

27. The device according to claim 13, wherein the forming tube is embodied as hollow.

28. The device according to claim 14, wherein the forming tube is embodied as hollow.

29. The device according to claim 11, wherein the forming tube is embodied as adjustable with regard to its diameter.

30. The device according to claim 11, further comprising a lateral sealing device operable to produce tubular bags from the manufactured tube.
